(19) United States
(12) Patent Application Publication
(10) Pub. No.: US 2009/0269725 A1
(43) Pub. Date: Oct. 29, 2009

(54) My jolly family method for enhancing family unity

(76) Inventor: Angela McLean, Atlanta, GA (US)

Correspondence Address: J.T. HOLLIN, ATTORNEY AT LAW, PC, 110 HABERSHAM DRIVE, SUITE 144, FAYETTEVILLE, GA, 30214, US

(21) Appl. No.: 12/148,850

(22) Filed: Apr. 23, 2008

(51) Int. Cl. G09B 11/10; G09F 3/00

(52) U.S. Cl. 434/84; 40/299.01

(57) ABSTRACT

A method is presented by which a family may publicly or privately express its unity, pride, and enjoyment of each other. A varied selection of ethnic, cultural, and/or generational features typically found in a cross-section of the population of any selected nation or geographic locale are fashioned by a portrait artist and a graphic artist into a collection of family caricatures. A family member, or the consensus of the entire family, selects from among the catalogued caricatures, suitable figures to identify with their own cultural and lifestyle traditions.

Stylized renditions of specific pursuits or activities commonly engaged in by a selected family are also offered, as are any family activities or pursuits of a serious or solemn nature. The combination of the caricatures and activities are rendered in full color by a professional artist, including clothes, accessories, and various other items, in accordance with the family's selections. The caricatures chosen by the family are then produced and affixed to any of a plurality of display mediums.

### CROSS-REFERENCES TO RELATED APPLICATIONS

U.S. Patent Documents

| Patent # | Classification | Date | Inventor |
|---|---|---|---|
| 4,483,680 | 434/154 | November, 1984 | Daly, L. |
| 4,834,657 | 434/238 | May, 1989 | Gonzalez, J., et al. |
| 4,865,548 | 434/154 | September, 1989 | Snyder, H. |
| 5,013,246 | 434/236 | May, 1991 | Doyle, N. |
| 5,246,374 | 434/154 | September, 1993 | Boodram, A. |
| 5,549,940 | 428/31 | August 1996 | Noone, R., et al. |
| 5,751,590 | 700/233 | May, 1998 | Cannon, T., et al. |
| 6,524,108 | 434/154 | February, 2003 | Murray, R. |
| 6,697,824 | 709/229 | February, 2004 | Bowman-Amuah, M. |
| 6,899,541 | 434/236 | May, 2005 | Kassai, K., et al. |
| 7,016,882 | 706/13 | March, 2006 | Afeyan, N., et al. |
| 7,264,474 | 434/236 | September, 2007 | Sullivan, J. et al. |

U.S. Patent Application Publications

| | | | |
|---|---|---|---|
| 20010037594 | 40/594 | November, 2001 | Bohen, R. |

### FOREIGN PATENT DOCUMENTS

Not applicable.

### OTHER PUBLICATIONS

“How to Build Family Unity;” Laurie Walker; Pagewise 2002

### FEDERALLY SPONSORED RESEARCH OR DEVELOPMENT

There are no federally sponsored research or development projects in connection with this invention.

### BACKGROUND OF THE INVENTION

(1) Field of the Invention

This invention relates generally to a system and method for nuclear families to demonstrate, via light-hearted artistic caricatures, their family love and harmony, and their commitment to, and participation in certain activities. These activities represent those physical, occupational, and/or recreational pursuits which will emphasize and display the family's (or family member's) fondness both for the pursuit and for each other.

American families have generally always been aware of and appreciative of their most prized family traditions and values. Similar to the macroscopic concepts wherein a family may trace its genealogical roots back for hundreds of years in the past and produce and preserve diaries, historical records, photographs, and family trees, this inventive concept presents a microscopic display of a single family's, or family member's values and interests.

All over the world there can be found among families varying degrees of interest in ways to record, teach, and preserve genealogical information in order to strengthen family bonds and inform the youngest members of the family tree of their distant history. In the same vein, this inventive concept, as explained in the method described herein, serves to emphasize family bonds. Where there are children in the family, they are given an indication that the parents and the family unit are proud of their involvement in, and dedication to a particular activity or certain inspiring beliefs. The same beneficial objectives are obtained even in situations where the family unit is composed of only a couple.

(2) Description of the Related Art

There is a dearth of patents that have been issued which relate to matters concerning the enhancement of family unity and harmony. Practically all previous inventions of this nature feature the use of games, genealogical cards, charts, or photographic displays in some form or other. These devices and methods tend to serve the purpose of encouraging family members to familiarize themselves with their history and traditions.

One well-studied author recommends that each family member write about three strengths or admirable qualities about any other family member, which in turn helps all to enjoy responding in a positive way to one another. Sharing what each has written and comparing or contrasting responses further elaborates the connection to the family member being considered. The act of writing becomes a physical display and commitment of emotions, pride, and appreciation toward the particular family member.

U.S. Pat. No. 4,483,680 is involved with a method of recording and displaying the name and vital statistics of individual members of a family in a variety of discrete patterns which patterns may then be imprinted on a transparent material so as to be suitable for display.

U.S. Pat. No. 4,865,548 features a three-dimensional genealogical display of a family tree which is constructed with a number of transparent planes in a vertical assembly. Each transparent plane represents a family generation. One object of this invention is to present the family relationships in such a way that all members of a family generation may be quickly and easily identified visually as members of a common generation. Similarly, U.S. Pat. No. 6,524,108 is also a three-dimensional family tree, but composed of a plurality of family member blocks. Each block has a family member identification printed upon it and is constructed with an edge design that permits each block to be joined together in a manner representing familial inter-relationships.

In U.S. Pat. No. 5,013,246, a method of promoting self-esteem is disclosed by the use of a gift kit consisting of a container of small chips. Each chip placed in the container is designed and printed with the admirable and unique qualities of the individual who is the intended recipient of the gift. The object of the invention is to encourage the recipient of the gift kit to be more cognizant of his/her own admirable qualities while increasing their feelings of being valued and appreciated.

U.S. Pat. No. 5,246,374 is a device which resembles a small artificial tree upon whose branches are attached photographs of family members, each photograph being attached as a leaf growing from the appropriate branch of the tree

U.S. patent application publication #20010037594 presents a method of showing a customized family display. The display is configured with simple, generic-stylized figures representing a male adult, a female adult, a male child, or a female child, and smaller figures representing either a pet dog or cat. A customer may therefore select the correct type and number of figures to reflect the composition of his/her family and attach the figures to a decal, which decal has circumferentially printed on it the slogan, “I Love My Family.” In its preferred embodiment, the decal is intended to be displayed on the back of a automotive vehicle.

U.S. Pat. No. 6,899,541, originally filed as a Japanese patent application, is entitled a “life log” and is a journal containing playful caricatures representing the evolving stages of a child's life. Its main object is to produce the affection from a parent to a child in visual form so that the parent(s) and child can share in the familial affection, joy, and emotions throughout life. The family becomes a nurture unit so that a good environment can be established for the child's mind.

### BRIEF SUMMARY OF THE INVENTION

This inventive concept presents a method for family members to publicly express their unity, pride, and enjoyment not only of each other, but also of a specific pursuit or activity participated in by an individual family member, which in turn, is enthusiastically supported by the remainder of the family. Customers who desire to display this type of unity and harmony may select from a variety of ethnic, cultural, and generational caricatures to identify with their own sociological or home environment. The caricatures have been rendered in color by a professional artist. The customer is provided with assorted selections of clothing accessories, sports, and/or hobby accouterments, and other items to correspond with the selected caricature(s). Family customers may purchase such family renderings through several media, including Internet, television commercials, shopping mall billboards, and mail-order catalogs.

In the preferred embodiment, the method is initiated by the family as a complete unit or, by an individual family member selecting an activity, a favorite past time, or an object or icon representing an entity which the entire family is most enthused about or committed to. The resulting artistic renderings of the selections made by the family are then displayed by means of decals, either permanently or temporarily affixed to a selected window (other than the windshield) of an automotive vehicle. However, the caricature selections made by the family members may be reproduced and displayed in an unlimited number of ways, restricted only by the family's imagination.

### BRIEF DESCRIPTION OF THE VIEWS OF THE DRAWINGS

FIG. 1 depicts the method by which the essential inputs of matters relating to the family's physical personifications and core values are gathered and synthesized by skilled artists in preparation for the final rendering of the graphic, light-hearted caricatures of the family.

FIG. 2 illustrates the method by which the family caricatures are advertised, marketed, sold, and distributed as customers make their selections.

### DETAILED DESCRIPTION OF THE INVENTION

The object of this inventive concept is to provide customers of every cultural and ethnic persuasion a means by which they may select from a variety of light-hearted caricatures and accessories that represent meaningful features and qualities of their family, thereby enhancing their family love and unity.

Through this inventive concept, a family is invited and encouraged to express, publicly or privately, their fondness and appreciation of each other, as individual family members, and/or as a close-knit group. It is a known and accepted fact that the United States is the “melting pot” of the world, offering freedom, opportunity, and acceptance to millions of people of all cultures, races, nationalities, and religions. Regardless of whether an American is native-born or a relatively recent naturalized citizen, he or she is welcome to engage in the full benefits of the American social and economic system while still honoring and giving respect to the family's spiritual and cultural traditions.

Although divorce rates and an increasing number of single-parent homes are troubling to people all over, civilizations throughout time have almost universally envisioned a happy home to include children, family traditions, and a secure setting for all family members to pursue wholesome activities within and outside the home. In that light, the method disclosed herein is intended to offer a light-hearted presentation of a myriad of family activities and an unlimited selection of caricatures representing the particular cultural features and activities of any given family.

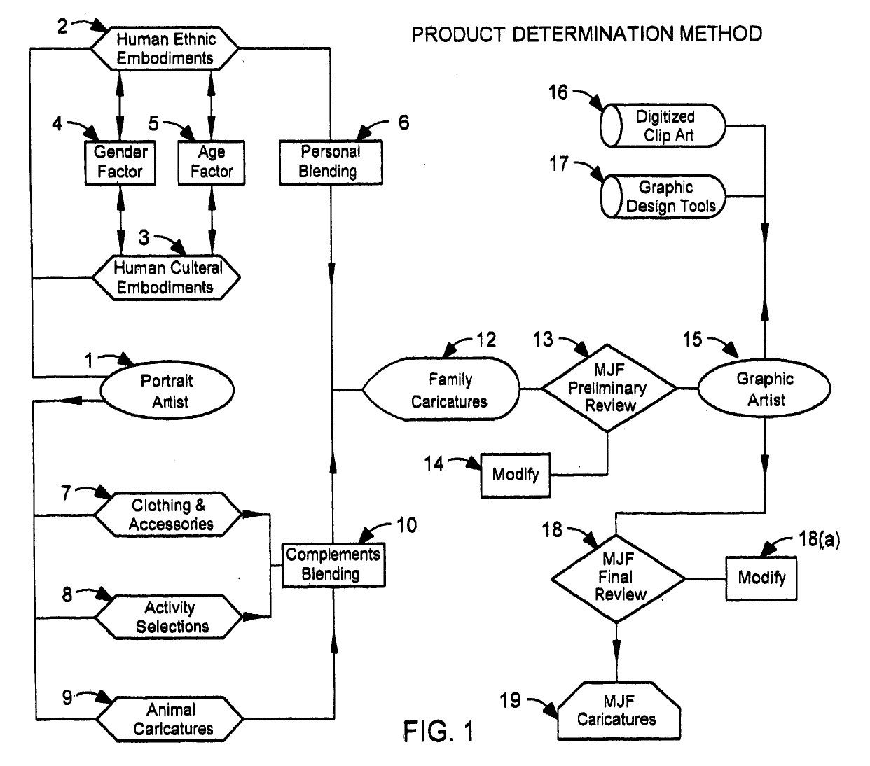

In viewing FIG. 1, it is seen that the method originates in the creative drive of a skilled portrait artist 1 who begins by visualizing an artistic rendering of the physical features of at least one person in the subject family group. Generic renderings of four basic human embodiments are first envisioned: an adult male, an adult female, a male child, and a female child. The portrait artist 1 then modifies the four embodiments with further physical features usually found in the various ethnic 2 or cultural 3 groups populating the particular nation selected. For example, in the United States, the predominant ethnic groupings 2 include European-American, African-American, Latin-American, Asian, and Native-American persons.

Among the physical features considered at the conceptual stage are the salient ethnic characteristics 2, the cultural distinctions 3, the family member's gender 4, and lastly, the age or generational factor 5. Cultural distinctions 3 may include a family's religious traditions, the national origin of older generation family members, geographic location, inherited or natural skills or talents, musical taste, and other factors. Taking all the initial physical and cultural characteristics into consideration, the portrait artist 1 then merges them into a personal blending 6 of the family member's most positive features and attributes.

Next, the artist 1, based on information received from a prospective customer order, or a specific family request, gives consideration to the appropriate clothing 7, compatible accessories 8, and a designated pursuit or activity 9. Knowing the pose or setting which the family or family member desires for that individual, the artist 1 then combines these auxiliary features, 7, 8, and 9, into a total complementary blending 10. The result at this stage is the first entry into the preliminary collection of family caricatures 12.

Afterwards, the portrait artist 1 repeats the same sequence of creative, selective renderings to arrive at an individual personal blending 6 and the associated complementary blending 10 for each of the remaining family members. In the event a pet or pets are part of the family, the artist 1 will again visualize and render the appropriate animal caricatures 11 for each pet, which will also be added to the total collection of family member caricatures 12.

From this point, each new addition to the collection of family caricatures 12 is reviewed by the company staff 13, which may determine that a modification 14 may be appropriate prior to approving a final rendering of each caricature. The next step in this inventive concept is to transmit the collection to a graphic artist 15 who will then make the finishing touches on the caricatures. The graphic artist 15 will utilize current graphic design tools 17 and selections of digitalized clip art 16 to “clean up” and add further distinguishing details to the caricatures in the family collection 12.

The graphic artist 15 then submits his finished renderings of the gamily caricatures to the staff of the company for a final review 18 of the artwork. Again, the company staff may choose to modify 18(a) certain caricatures before finalizing the renderings. Thereafter, the finished caricatures 19 are ready to be displayed in select advertising media, sold to consumers, and shipped to the respective customers who placed the orders.

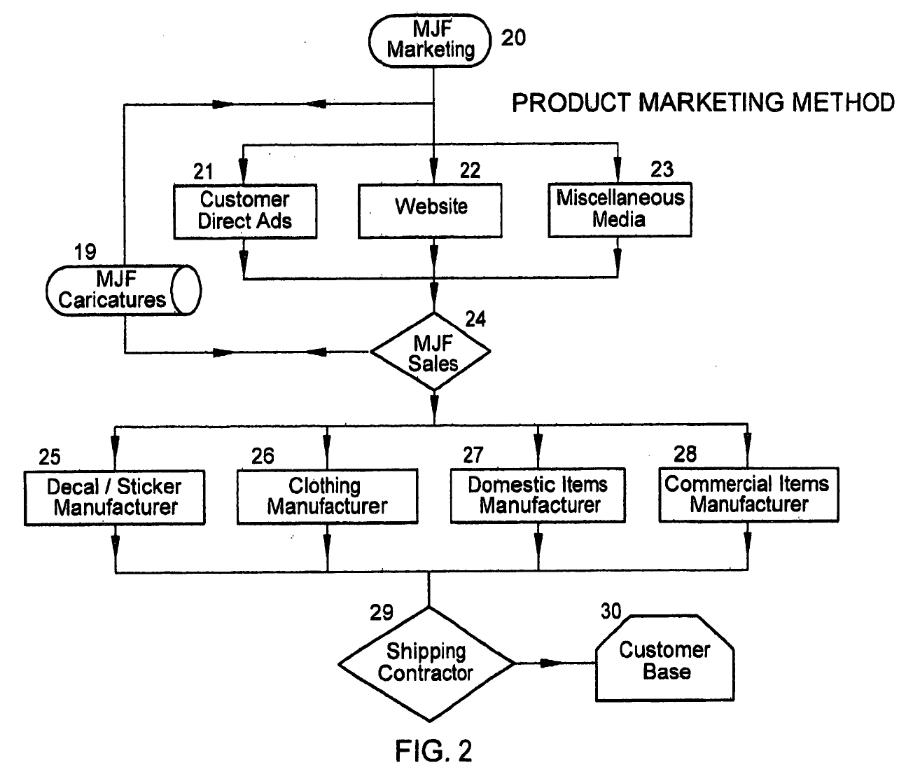

As we view FIG. 2, the method of marketing the family unity caricatures is presented. The company's marketing section 20 has direct access to a substantial collection of previously drawn caricatures 19 which have been digitally stored. It should be noted that this inventive concept does not negate the capacity of the company and its artist contractors to accept customer orders for accurate customized renderings of family caricatures from actual or digitalized photographs of the family members.

The company's marketing section 20 has direct access to a substantial collection of previously drawn family caricatures 19 which have been digitally stored. The marketing manager arranges for display of typical samplings of family caricatures through such media as direct consumer ads 21 placed in magazines, newspapers, television ads, well-designed Internet websites 22, and various other advertising channels 23.

As a result of customer responses to the company's advertising placements, the company's sales department 24, or a sub-contracted firm will process the customer payments, catalog the orders received, and prepare the appropriate electronic tagging of each customer order to be transmitted to various manufacturers. The selection of a particular manufacturer is entirely dependent on the display format chosen by the family. The family caricature orders may be affixed to a decal or sticker 25, clothing 26, certain household goods or domestic items 27, or a variety of commercial goods 28 that are amenable to the process of attaching the renderings of the family caricatures. Once the family caricatures are attached to a selected display medium, as processed at the manufacturer's facility, the goods are then processed by a shipping contractor 29 which takes the final step of packaging, labeling and shipping the selected products to customers 30.

It is recognized that there are unlimited means of processing goods sold in commerce and the methods disclosed in this inventive concept are not intended to be exclusive of other methods or procedures of which the company may avail itself in order to be economically and strategically effective.

What is claimed is:

1. A method of enhancing the unity, harmony, and love of a family, each member of the family for the other, comprising
a) rendering, by an artist, of full color caricatures of the likenesses of human beings, such caricatures based on a plurality of ethnic, cultural, gender, and generational features or characteristics of humans around the world; and
b) rendering, by the artist, of caricatures of the clothing, accessories, and personal accouterment characteristic of the entirety of, or segments of, the population of any selected sovereign nation, geographic locale, or political region of the world; and
c) blending, by the artist, of the said renderings set forth in paragraphs a) and b) of this claim, into a plurality of individual human caricatures depicted in a variety of settings, activities, and/or emotional states; and
d) imprinting on any of the said settings, the phrase “My Jolly Family.com;” and
e) storing, in an electronic database, said individual human caricatures; and
f) designing and making available to the general public, by means of advertising and electronic media, sufficient menu or category selections by which a viewer of the advertisement(s) may select a combination of i) any of the displayed said human caricatures and ii) any of the desired clothing, accessories, and/or accouterment so as to form a collected family unit caricature; and
g) subjecting the said family unit caricature to a suitable process as to render the family unit caricature amenable for affixing to any of a plurality of display mediums that may be selected by the viewer; and
h) exhibiting, publicly or in private, by any or all of the family members, or by any other person, the family unit caricature as depicted upon a selected display medium.

2. A method of enhancing the unity, harmony, and love of a family, one for the other, comprising
a) rendering, by an artist, of a full color caricature of the likeness of each member of a specific family; and
b) rendering, by the artist, of clothing, accessories, personal accouterment, and/or an activity specifically selected by the said family member, or in the stead of the said family member; and
c) blending, by the artist, of the said renderings set forth in paragraphs a) and b) of this claim, herein, into a complete family member caricature; and
d) repeating steps a) through c) of this claim for each member of the said family; and
e) combining, by the artist, of all the individual complete family member caricatures into one artistic setting, so as to depict a collected family unit caricature; and
f) further, imprinting on the said artistic setting the phrase, “My Jolly Family.com;” and
g) subjecting the said collected family unit caricature to an appropriate process so as to render the family unit caricature amenable for affixing to a display medium selected by the family; and
h) exhibiting publicly or in private, by any or all of the family members, the family unit caricature as depicted upon the selected display medium.

3. A method, as in claim 2, of enhancing the unity, harmony, and love of a family, one family member for the other, further comprising
a) rendering, by an artist, of a full color caricature of the likeness of each member of a specific family, said rendering based upon a photograph or photographs furnished to the said artist; and
b) rendering, by the artist, of clothing, accessories, personal accouterment, and/or an activity specifically selected by the said family member, or in the stead of the said family member; and
c) blending, by the artist, of the said renderings set forth in paragraphs a) and b) of this claim, herein, into a complete family member caricature; and
d) repeating steps a) through c) of this claim for each member of the said family; and
e) combining, by the artist, of all the individual complete family member caricatures into one artistic setting, so as to depict a collected family unit caricature; and
f) imprinting on the said artistic setting the phrase, “My Jolly Family.com;” and
g) subjecting the said collected family unit caricature to an appropriate process so as to render the family unit caricature amenable for affixing to a display medium selected by the family; and
h) exhibiting publicly or in private, by any or all of the family members, or by any other person, the family unit caricature as depicted upon any selected display medium.

4. A family unity display affixed, by a suitable means, to the surface of any of a plurality of objects, said family unity display comprising
a) a full color print of a collection of the individual caricatures of a family, said collection referred to as a family unit caricature, and said family unit caricature formed by the steps of
i) a rendering, by an artist, of a full color caricature of the likeness of each member of the family; and
ii) a rendering, by the artist, of clothing, accessories, and personal accouterment and/or an activity specifically selected by, or in the stead of the said family member; and
iii) blending, by the artist, of the said renderings set forth in paragraphs a) i) and ii) of this claim, into a complete family member caricature; and
iv) repeating steps a) i) through a) iii) of this claim for each member of the said family; and
v) combining, by the artist, of all the individual family member caricatures into one artistic setting, so as to depict the collected family unit caricature; and
vi) imprinting on the surface of any selected object, the phrase, “My Jolly Family.com;” and
vii) subjecting the said collected family unit caricature to an appropriate process so as to render the family unit caricature amenable to affixing to the surface of an object or objects that may be selected.

5. A family unity display as in claim 4, further comprising a family unity display in the form of a window decal, said window decal comprising
a) a sheet of printable material having a front face and a back face, the said front face having printed on its surface a collection of the individual caricatures of a family, referred to as a family unit caricature, said family unit caricature formed by the steps of
i) a rendering, by an artist, of a full color caricature of the likeness of each member of the family; and
ii) a rendering, by the artist, of clothing, accessories, and personal accouterment and/or an activity specifically selected by the said family member, or in the stead of the said family member; and
iii) blending, by the artist, of the said renderings set forth in paragraphs a) i) and ii) of this claim, into a complete family member caricature; and
iv) repeating steps a) i) through a) iii) of this claim for each member of the said family; and
v) combining, by the artist, of all the individual family member caricatures into one artistic setting, so as to depict a collected family unit caricature; and
vi) imprinting on the front face of the said printable material the phrase, “My Jolly Family.com;” and
vii) subjecting the said collected family unit caricature to an appropriate process so as to render the family unit caricature amenable to affixing to the front face of the window decal; and
b) affixing to the back face of the window decal a suitable adhesive substance, either of a permanent adhesive composition or of a “peel-away”-type adhesive composition.

6. The method, as in claim 1, further comprising
a) rendering, by an artist, of full color caricatures of the likenesses of human beings, such caricatures based on a plurality of ethnic, cultural, gender, and generational features or characteristics of the population of the United States of America; and
b) rendering, by the artist, of caricatures of the clothing, accessories, and personal accouterment typically found in the entirety of, or segments of, the population of the United States; and
c) blending, by the artist, of the said renderings set forth in paragraphs a) and b) of this claim, into a plurality of individual human caricatures depicted in a variety of settings, activities, and/or emotional states; and
d) imprinting on any of the said settings, the phrase “My Jolly Family.com;” and
e) storing, in an electronic database, said individual human caricatures; and
f) designing and displaying to the general public, by means of advertisements on traditional and electronic media, sufficient menu and/or category selections by which a viewer of the advertisement(s) may select a combination of i) any of the displayed said human caricatures and ii) desired clothing, accessories, and/or accouterment so as to form a collected family unit caricature; and
g) subjecting the said family unit caricature to a suitable process as to render the family unit caricature amenable to affixing to any of a plurality of display mediums that may be selected by the viewer; and
h) exhibiting, publicly or in private, by any or all of the family members, or by any other person, the family unit caricature as depicted upon a selected display medium.
